(19) United States
(12) Patent Application Publication
(10) Pub. No.: US 2025/0243093 A1
(43) Pub. Date: Jul. 31, 2025

(54) STACKABLE WASTEWATER TREATMENT CHAMBERS AND INSTALLATION METHOD THEREOF

(71) Applicant: 11814192 CANADA INC., Sherbrooke (CA)

(72) Inventors: Benoit Boucher, Sherbrooke, QC (CA); Marc-Andre Favreau Boucher, Sherbrooke, QC (CA)

(21) Appl. No.: 18/704,772

(22) PCT Filed: Oct. 6, 2022
(86) PCT No.: PCT/CA2022/051480

§ 371 Date: Apr. 25, 2024

Related U.S. Application Data
(60) Provisional application No. 63/264,414, filed on Nov. 22, 2021.

(51) Int. Cl. C02F 3/10; C02F 103/00

(52) U.S. Cl. CPC C02F 3/101; C02F 3/108; C02F 2103/005; C02F 2203/006

(57) ABSTRACT

A stackable half-tubular assembly is presented. The assembly comprises wall sections defining cavities. The wall sections are secured to one another about a securing portion, wherein the stackable assembly is configured to be assembled with a stackable assembly of the same configuration to form a plurality of enclosed drains for housing a fluid. A method of installation is also provided, the method comprising aligning and securing two stackable half-tubular assemblies together.

### CROSS-REFERENCE TO RELATED APPLICATIONS

The present patent application claims the benefits of priority of U.S. Provisional Patent Application No. 63/264,414, entitled “STACKABLE WASTEWATER HALF-DRAIN AND INSTALLATION METHOD THEREOF” and filed at the United States Patent and Trademark Office on Nov. 22, 2021, the content of which is incorporated herein by reference.

### FIELD OF THE INVENTION

The present invention generally relates to the field of wastewater and sewage treatment basins and of installation methods thereof. More particularly, the present invention generally relates to a stackable wastewater treat for use in septic systems and of installation methods thereof.

### BACKGROUND OF THE INVENTION

Septic systems are typically used in areas, regions or countries that are not connected to a sewage system, such as rural areas or undeveloped countries. Consequently, materials and equipment are typically transported long distances before reaching the installation site. As such, transportation costs can represent a substantial portion of the total costs of the total installation costs.

Moreover, traditional septic systems typically rely on long drainage conduits configured to distribute effluent over the span of a drainage field. These hollow tubes serve a crucial role in the treatment of wastewater but can occupy a lot of space prior to installation. As transportation costs are commonly related to the volume of the transported materials, there is therefore continued interest in minimizing the transport size of equipment and, concordantly, transportation costs.

There is therefore a need for a stackable wastewater treatment basin capable of being stacked in an unassembled configuration to occupy less volume during storage and/or transportation and a method of installation thereof.

### SUMMARY OF THE INVENTION

The present invention is directed to a stackable half-tubular assembly securable to another stackable half-tubular assembly. Each stackable half-tubular assembly may comprise more than one half-tubular sections allowing to form a plurality adjacent or parallels drains when assembled with another stackable half-tubular assembly.

The present document interchangeably refers to the stackable half-tubular section or assembly and to stackable wastewater treatment chamber or basin section. Understandably, the stackable wastewater treatment chamber or basin section may have any other section shape than half-tubular such as but not limited to half oval, half rounded square or rectangle, etc.

In one aspect of the invention, a stackable wastewater treatment basin section is provided. The stackable wastewater treatment basin section comprises a wall defining one or more cavities, the one or more elongated cavities being configured to retain wastewater, an inner side of the wall being adapted to receive an outer side of the wall of another stackable wastewater treatment basin section of the same configuration.

The stackable wastewater treatment basin section may comprise two cavities and a securing portion between each of the two elongated cavities. Each cavity may comprise an outer lip adapted to be secure to an outer lip of another stackable wastewater treatment basin section of the same configuration.

The stackable wastewater treatment basin section may comprise a securing portion adapted to mate with a securing portion of another stackable wastewater treatment basin section. The securing portion may allow relative adjustments between the two or more half-tubular wall sections.

The stackable wastewater treatment basin section may comprise corrugations along each the inner wall section, the corrugations being adapted to mate with corresponding corrugations present on an outer wall of another stackable wastewater treatment basin section. The cavity may be U-shaped.

The stackable wastewater treatment basin section may comprise stacking connectors on an inner side of the wall mating with stacking connectors of an outer side of a wall of another stackable wastewater treatment basin section.

The stackable wastewater treatment basin section may comprise a filtering layer over an outer surface of the cavity. The filtering layer may extend away from extremities of the stackable wastewater treatment basin section.

The stackable wastewater treatment basin section may comprise ports configured to allow fluid communications with other fluid systems. The ports may be detachable.

The stackable wastewater treatment basin may comprise a first connector at a first longitudinal end and a second connector at a second longitudinal end, the first connector being configured to mate with a second connector of another stackable wastewater treatment basin section.

In another aspect of the invention, a wastewater treatment basin assembly is provided. The assembly comprises a first and second stackable wastewater treatment basin sections, each stackable wastewater treatment basin section comprising a wall defining one or more elongated cavities, the one or more cavities being configured to retain wastewater, an inner side of the wall being adapted to receive an outer side of the wall of another stackable wastewater treatment basin section of the same configuration. The first and second wastewater treatment basin sections are attached to one another to form an enclosed wastewater treatment basin adapted to receive a fluid.

Each of the first and second wastewater treatment basin sections may comprise two cavities and a securing portion between each of the two elongated cavities. Each cavity may comprise an outer lip adapted to be secure to an outer lip of another stackable wastewater treatment basin section of the same configuration. The securing portion may allow relative adjustments between the walls of the two cavities.

Each stackable wastewater treatment basin section may comprise corrugations along its inner wall section, the corrugations being adapted to mate with corresponding corrugations present on an outer wall of another stackable wastewater treatment basin section. Each stackable wastewater treatment basin section may also comprise male and female securing means configured to secure the first stackable wastewater treatment basin section to the second stackable wastewater treatment basin section.

In yet another aspect of the invention, a method of installing a wastewater treatment basin is provided. The method comprises laying a first stackable wastewater treatment basin section on a surface for an inner wall defining one or more elongated cavities to face upward, positioning a second stackable wastewater treatment basin section on top of the upwardly facing cavity of the first stackable wastewater treatment basin section to form an enclosed wastewater treatment basin between the inner walls of the cavities of the first and second stackable wastewater treatment basin sections, and securing the first stackable wastewater treatment basin to the second stackable wastewater treatment basin.

The method may further comprise surrounding the positioned first and second stackable wastewater treatment basin sections with a filtering membrane.

The method may further comprise aligning a first securing connector of the first stackable wastewater treatment basin section with a second securing connector of the second stackable wastewater treatment basin section, and securing the first and second connectors to one another. The method may further comprise mating a first connector at a first longitudinal end of the formed wastewater treatment basin to a second connector at a second longitudinal end of another formed wastewater treatment basin. The method may further comprise fluidly connecting a port of the formed wastewater treatment basin to another fluid system.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a top perspective view of an exemplary assembled stackable half-tubular assemblies forming a plurality of assembled drains in accordance with the principles of the present invention.

FIG. 2 is a right view of the stackable half-tubular assemblies of FIG. 1.

FIG. 3 is a top plan view of the stackable half-tubular assemblies of FIG. 1.

FIG. 4 is a rear view of the stackable half-tubular assemblies of FIG. 1.

FIG. 5 is a top rear perspective view of an exemplary stackable half-tubular assembly comprising two half-tubular sections in accordance with the principles of the present invention.

FIG. 6 is a top perspective view of the stackable half-tubular assembly of FIG. 5.

FIG. 7 is a bottom perspective view of the stackable half-tubular assembly of FIG. 5

FIG. 8 is a top plan view of the stackable half-tubular assembly of FIG. 5.

FIG. 9 is a bottom plan view of the stackable half-tubular assembly of FIG. 5.

FIG. 10 is a right elevation view of the stackable half-tubular assembly of FIG. 5.

FIG. 11 is a front elevation view of the stackable half-tubular assembly of FIG. 5.

FIG. 12 is a rear elevation view of the stackable half-tubular assembly of FIG. 5.

FIG. 13 is a top plan view of another exemplary stackable half-tubular assembly forming four (4) drains in accordance with the principles of the present invention.

FIG. 14 is a rear elevation view of two exemplary stackable half-tubular assemblies comprising filtering layers in accordance with the principles of the present invention.

FIG. 15 is a perspective view of the stackable half-tubular assembly of FIG. 5 shown stacked with complementary stackable half-tubular assemblies in accordance with the principles of the present invention.

FIG. 16 is a perspective view of an exemplary stackable half-tubular assembly comprising connecting means and stacking connectors in accordance with the principles of the present invention.

FIG. 17 is a side sectional view of the stackable half-tubular assembly of FIG. 16.

FIG. 18 is side elevation view of an exemplary embodiment of a stackable wastewater treatment basin section having end connectors in accordance with the principles of the present invention.

FIGS. 19A and 19B are perspective views of two disconnected stackable wastewater treatment basin sections having end connectors in accordance with the principles of the present invention.

FIG. 19C is a perspective view of two connected stackable wastewater treatment basin sections having end connectors in accordance with the principles of the present invention.

### DETAILED DESCRIPTION OF THE PREFERRED EMBODIMENT

A novel stackable wastewater half-tubular assembly and installation method thereof will be described hereinafter. Although the invention is described in terms of specific illustrative embodiments, it is to be understood that the embodiments described herein are by way of example only and that the scope of the invention is not intended to be limited thereby.

The systems and methods described herein incorporate a stackable wastewater half-tubular treatment basin assembly 10 configured to facilitate the storage, transportation and installation of a wastewater treatment system (not shown), such as, but not limited to, a treatment system described in international patent applications published under nos. WO 2020/041906 and WO 2020/248043. A wastewater treatment system typically comprises an input source, such as an input source or drainage pipe, a tank, such as a septic tank, and a drainage field. The septic tank may provide a first treatment of the wastewater, the output of which is referred to as effluent. The drainage field further comprises a leach system disposed between a plurality of ground layers.

The leach system comprises one or more treatment passages configured to fluidly receive and treat a fluid, such as effluent. The treatment passages may comprise elongated tubular members configured to convey and distribute the fluid. In some embodiments, the tubular members may be perforated pipes. The effluent flowing in the treatment passages may be conveyed by gravitational forces in tandem with the geometry of the treatment passages. In other embodiments, the effluent flowing in the treatment passages may be pressurized by a low-pressure distribution system or any other suitable pumping system (not shown).

In embodiments where the fluid comprises effluent, the effluent treated by microbial water treating bacteria within the leach system and filtered by a filtering medium may be defined as treated wastewater.

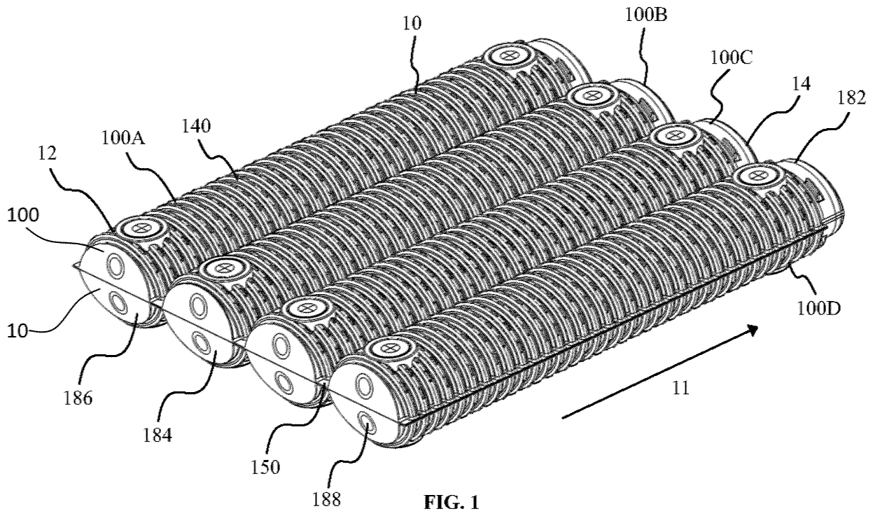

Referring now to FIG. 1, two stackable half-tubular wastewater treatment assemblies 10 are illustrated. The half-tubular assemblies 10 are illustrated in an assembled configuration to form treatment chamber or basins 100, specifically four treatment basins as shown (100A, 100B, 100C and 100D) having a cross-sectional shape defining hollow cavities adapted to accommodate the volume of water to be conveyed or disposed, such as the wastewater supplied by the drainage pipe and/or to accommodate the topographic requirements of the installation site. For example, the stackable half-tubular assembly 10, when combined with a similar half-tubular assembly 10, may form a channel or treatment passage having a cross-sectional shape defining a circle, an oval, a rectangle or any other suitable shape known in the art. Understandably, more or less than four treatment basins 100 may be comprised in a half-tubular wastewater treatment assembly 10.

The stackable half-tubular assemblies 10 may be made of any semi rigid material. Examples of possible construction materials include, but are not limited to, plastics such as polypropylene and polyethylene or flexible metal. Other polymers, fibrous material, metals, rubbers or rubber-like materials may also be used.

Similarly, the treatment passages 100 formed by two assembled stackable half-tubular assemblies 10 may have any length and/or cross-sectional area suitable to accommodate the volume of water to be conveyed or disposed supplied by the drainage pipe and/or to accommodate the topographic requirements of the installation site. In some embodiments, the treatment passages 100 may have a cross-sectional area of 175 cm2 to 2,000 cm2.

In certain embodiments, one or more of the stackable half-tubular assemblies 10 may comprise microbes. The microbes may be adapted to encourage an aerobic process to treat the effluent disposed within the assembled treatment basin or passages 100 by absorbing the organic waste, removing pathogens and breaking down the effluent into soluble by-products. In an embodiment, the stackable half-tubular assemblies 10, when combined to form the one or more treatment passages 100, are adapted to encourage the development of microbial water treating bacteria responsible for a secondary treatment of the wastewater. In particular, the stackable half-tubular assemblies 10, when combined, may be adapted to maintain a controlled flow rate of the effluent suitable for the growth of microbial water treating bacteria and may be geometrically configured to form spaces suitable for the growth of microbial water treating bacteria.

The stackable half-tubular assemblies 10 may further be corrugated to increase the structural flexibility and structural strength thereof. Understandably, the corrugation of the stackable half-tubular assemblies 10 may further encourage the growth of microbial cultures and may provide a greater surface area for the development of microbial water treating bacteria and may increase the contact surface between the microbial water treating bacteria and the effluent.

Still referring to FIG. 1, two stackable half-tubular assemblies 10 assembled to form four adjacent treatment passages or basins 100 are illustrated. The flow of the effluent within the assembled treatment passages 100 further defines a stream direction 11 wherein the beginning of the assembled treatment passages 100 in the direction of the stream direction 11 is defined as the upstream end 12 and the end of the assembled treatment passages 100 in the direction of the stream direction 11 is defined as the downstream end 14. In some embodiments, the downstream end 14 of the assembled treatment passages 100 may be configured to receive one or more end caps (not shown) which may be detachably affixed to each stackable half-tubular assembly 10 and may either partially or entirely limit the flow of the effluent outside of the downstream end 14.

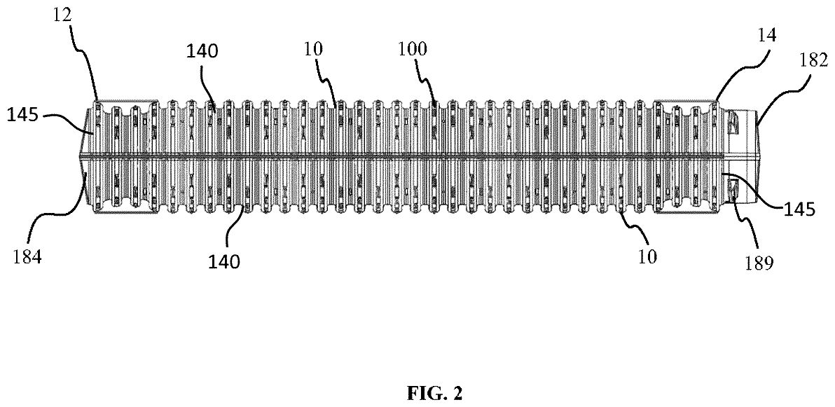

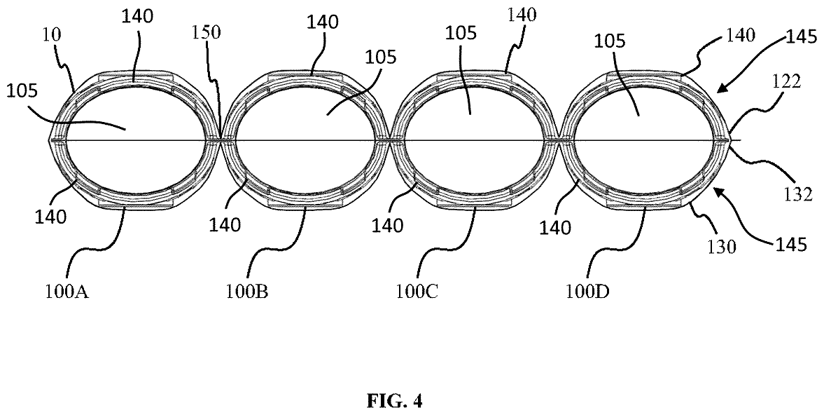

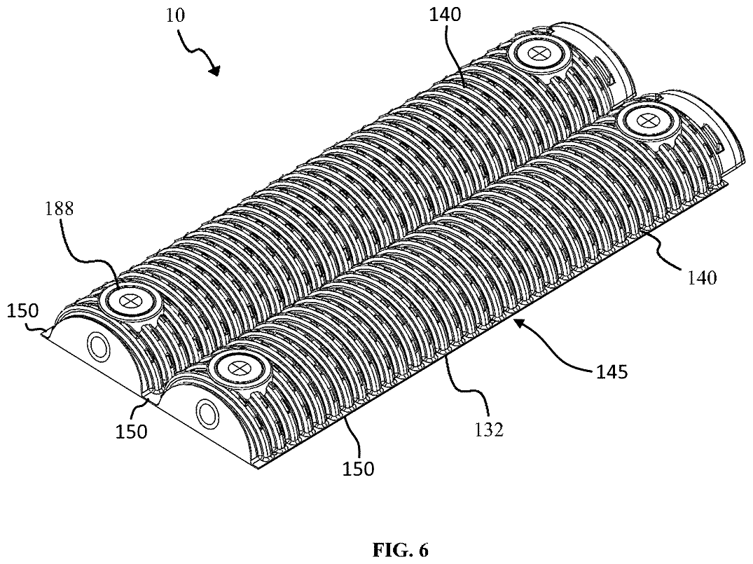

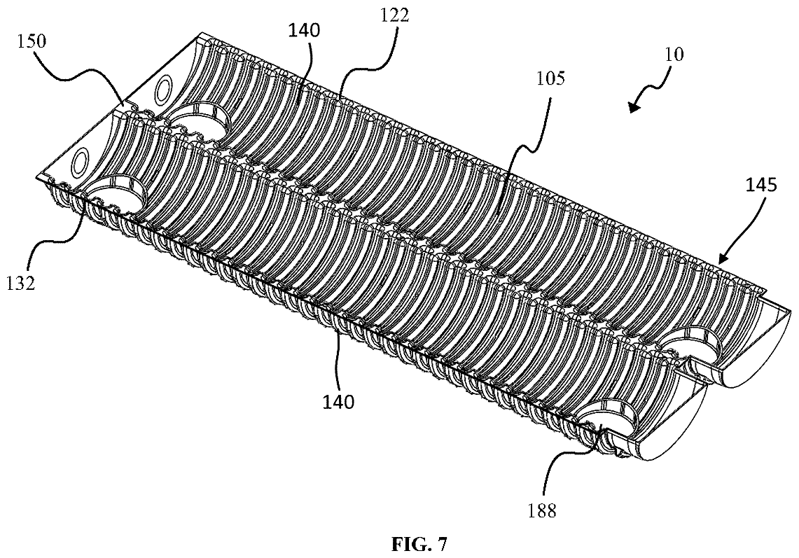

Referring now to FIGS. 2 and 4, each of half-tubular walls or half-tubular section 140 of a stackable half-tubular assembly 10 comprises at least one cavity or channel 105 (shown in FIG. 7) therein. To that end, each of the stackable half-tubular assemblies 10 may each comprise one or more half-tubular walls 140 defining a half-tubular section 145. When a half-tubular assembly 10 is assembled to another half-tubular assembly 10, the two half-tubular sections 145 of the half-tubular assemblies 10 define a cross-sectional shape of the assembled drain 100 as seen in FIG. 4. Understandably, each half-tubular 145 of a half-tubular assembly 10 may be configured to be stacked vis-à-vis with another half-tubular section 145 of another half-tubular assembly 10 so as to form the cavities 105.

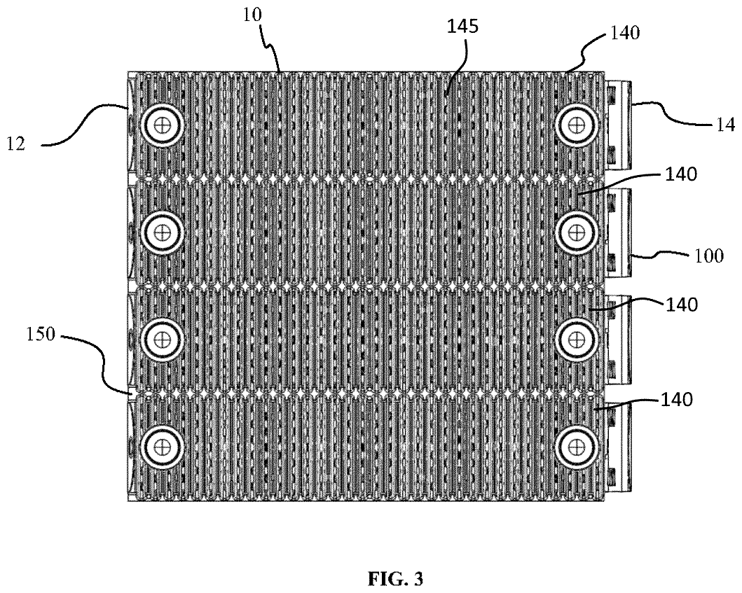

In certain embodiments, the assembled half-tubular assemblies 10 may comprise a plurality of conjoined treatment passages 100, wherein each formed treatment passage 100 comprises a distinct and fluidly independent channel 105. For example, in the embodiment of FIGS. 1 to 4, each of the half-tubular assemblies 10 comprises four wall sections 140 forming a half-tubular section 145. When assembled to another half-tubular assembly 10, four treatment passages 100A, 100B, 100C and 100D are formed. Accordingly, each of the half-tubular assemblies 10 may comprise a plurality of partitions or wall sections 140 wherein each wall section 140 defines a portion of a half-tubular section 145. Understandably, while four wall sections 140 defining four channels 105 are illustrated, any number of wall sections 140 may be conjoined to form any desirable number of channels 105 in a half-tubular section 145.

In such embodiments, each pairing of wall sections 140 in a half-tubular assembly 10 may comprise one or more rigid or semi-rigid securing portions 150. Each securing portion 150 is connected at one end to a first wall section 140 of and at another end to an adjacent wall section 140 of the half-tubular assembly 10. The securing portion 150 may allow limited adjustment relative to one another to allow the half-tubular assembly 10 to adapt with the topography of the surface upon which it is installed. Accordingly, the securing portion 150 may be configured to retain adjacent wall sections 140 in a fixed configuration relative to one another.

The securing portions 150 may comprise any resilient, rigid or semi rigid securing means configured to secure the adjacent wall sections 140 to one another. For example, the securing portions 150 may comprise a tab, a strip, one or more filaments, rivets, complementary clips, or any other suitable securing means capable of retaining the adjacent wall sections 140 in a fixed position relative to one another.

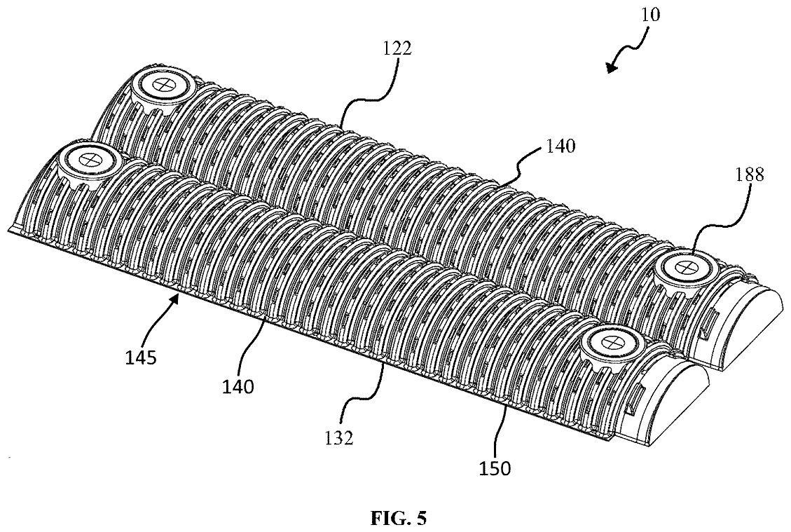

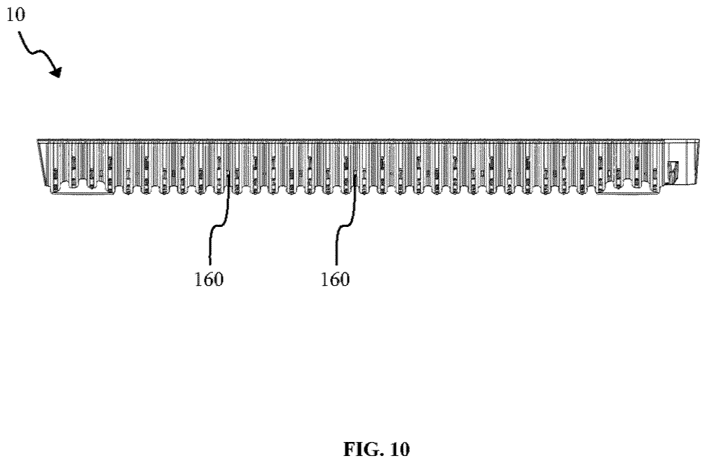

Referring now to FIGS. 5 to 12, another embodiment of a stackable half-tubular assembly 10 is illustrated. In such an embodiment, the stackable half-tubular assembly 10 comprises two wall sections 140. In the illustrated embodiment, the securing portion 150 may be made of the same material as the wall sections 140 and extend a substantial length thereof. As such, the wall sections 140 and securing/attaching portion 150 may form a single unitary piece. In such embodiments, the wall sections 140 and the securing portion 150 may be made of a flexible yet resistant material, such as a flexible plastic. In some embodiments, the stackable half-tubular assembly 10 is made using resistant plastic, such as being molded or using plastic injection.

As stated above, the stackable half-tubular assembly 10, when assembled to form the one or more treatment passages 100, is attachable to another half-tubular assembly 10 comprising the same number of wall sections 140.

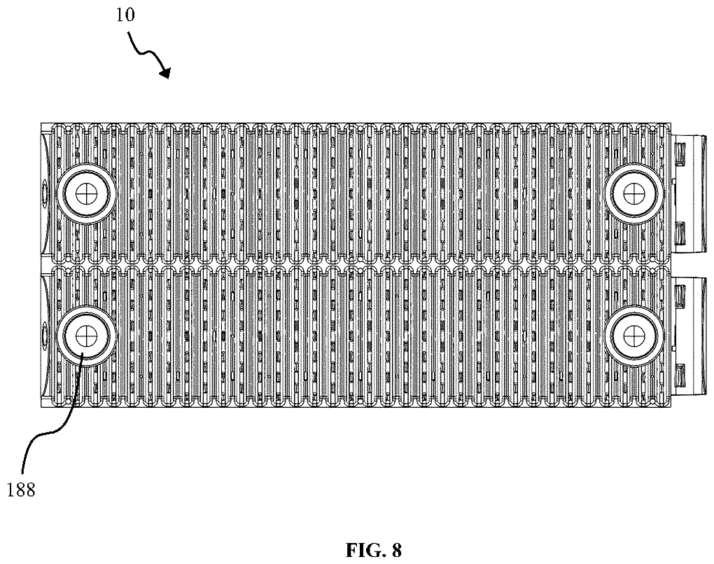

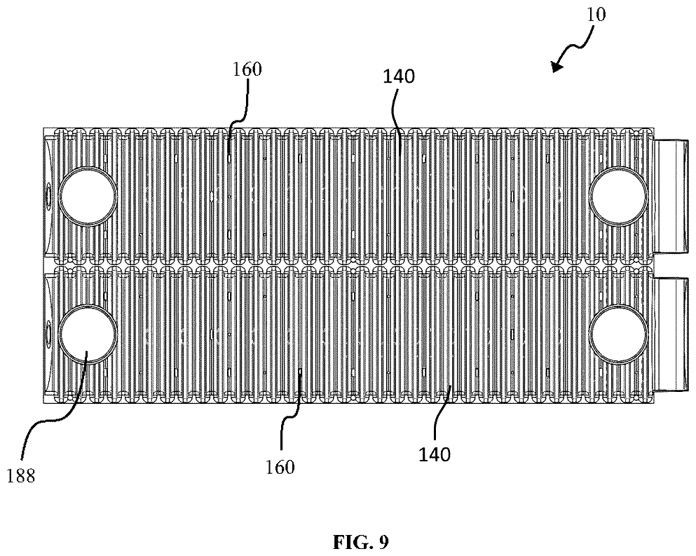

Referring again to FIGS. 1 to 4, an embodiment of two stackable half-tubular assemblies 10 attached one over the other to form a plurality of assembled treatment passages 100 is illustrated. In such an embodiment, as each stackable half-tubular assembly 10 comprises a plurality of wall sections 140, the attached stackable half-tubular assemblies 10 form the plurality of treatment passages defining the channels 105 (shown in FIGS. 7 and 9). The said channels 105 are suitable for channeling the fluid therein. As such, the two stackable half-tubular assemblies 10 may be permanently or removably affixed to one another in a predetermined configuration to form the channels 105.

The two stackable half-tubular assemblies 10 may be affixed to one another using any suitable means such as, but not limited, welding, sewing, stapling, screwing, clamping and gluing. Referring now to FIGS. 4 to 7, in the illustrated embodiment, two stackable half-tubular assemblies 10 may be interconnected by securing or affixing corresponding outer lateral edges 122 and 132 adapted to be attached to one another. In certain embodiments, the stackable half-tubular assemblies 10 may comprise complementary attachment sections, respectively, adapted to be interconnected or attached such as, for example, protuberances and recesses. It may be understood that in other embodiments, the attachment sections 122, 132 may be located anywhere on the stackable half-tubular assemblies 10. For example, an attachment section 122, 132 may be located at the securing portion 150.

Referring back to FIGS. 5 to 11, a stackable half-tubular assembly 10 is illustrated in an unassembled configuration. In certain embodiments, the attachment sections 122, 132 comprise a male and female connector allowing them to be mated to one another, such as, for example, by snapping the two portions together. Understandably, the first and second attachment sections 122, 132 may comprise any other known attachment means known in the art without extending beyond the scope of the invention.

The securing portion 150 of the stackable half-tubular assembly 10 may similarly adjoin a corresponding securing portion 150 of another stackable half-tubular assembly 10 such as to enclose the channels 105. Accordingly, the securing portions 150 of the two stackable half-tubular assembly 10 may similarly be adapted to sealingly connect with one another such as to fluidly isolate the adjacent channels 105. In other embodiments, the channels 105 may be fluidly isolated due to the interconnection between the two stackable half-tubular assemblies 10 along the securing portions 150 due to their curvature and geometry. In other embodiments still, the channels 105 may be isolated due to a combination of the above-described means.

In a further embodiment and as illustrated in FIGS. 9 to 12, the wall sections 140 of the stackable half-tubular assembly 10 may further comprise perforations 160 adapted to allow a release of the effluent outside of the assembled treatment passages 100. In a preferred embodiment, the size of the perforations 160, the number of perforations 160 and the distribution of perforations 160 are determined based on the conditions of operation. As an example, the characteristics of the perforations may be determined to ensure a steady release of the fluid, to ensure leaching into the surrounding soil and to distribute the fluid along a substantial portion of the assembled treatment passages 100 in response to the volume of water to be conveyed by the assembled treatment passages 100. It may be appreciated that a high number of perforations 160 or perforations 160 having large apertures may cause an undesirable amount of the fluid to be released early on in the assembled treatment passages 100 as defined by the stream direction 11. Accordingly, having too many perforations 160 or having perforations 160 with large apertures may limit the longitudinal distribution of the fluid to a first section of the assembled treatment passages 100. Similarly, a number of perforations being too low or perforations having small apertures may prevent a sufficient volume of the fluid to be released from the assembled treatment passages 100. In some embodiments, having an insufficient release of fluid may cause an undesirable accumulation thereof in the assembled treatment passages 100 or flooding of the assembled treatment passages 100.

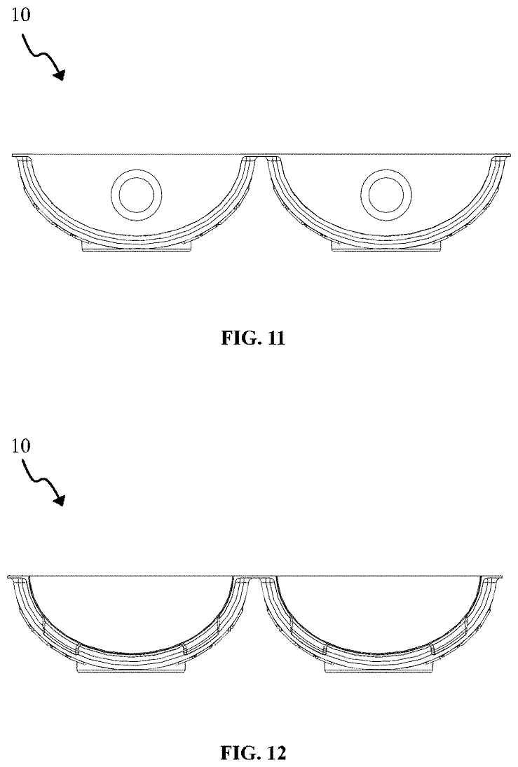

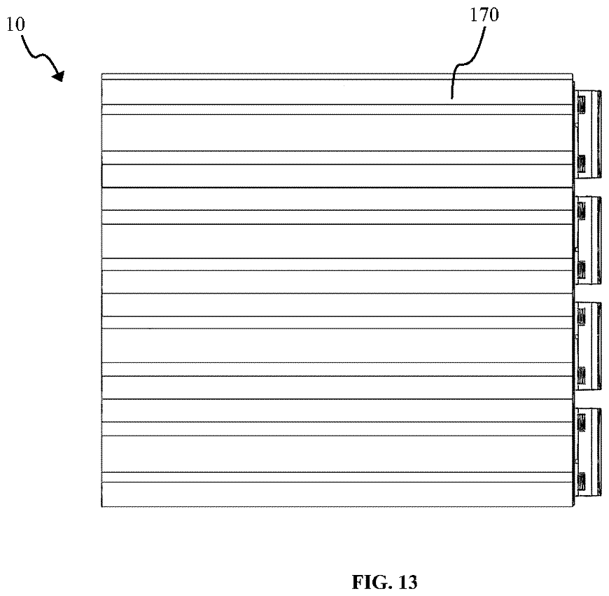

Referring now to FIG. 13, the stackable half-tubular assembly 10 may further comprise one or more layers of porous or filtering membranes 170, such as fabric membranes, adapted to wrap said stackable half-tubular assembly 10 and to facilitate the leaching of the fluid into the surrounding soil. The membranes 170 may comprise any suitable synthetic media for the leaching of fluids. The membranes 170 may further facilitate the fixation of microbial water treating bacteria supporting treatment of the fluid, when the fluid comprises an effluent. The membranes 170 may further support a longitudinal distribution of the fluid along the stackable half-tubular assembly 10. The filtering membranes 170 may be fastened to the stackable half-tubular wastewater treatment assembly 10 by any suitable means. In certain embodiments, the filtering membranes 170 are wrapped around one or more treatment passages 100 when the stackable half-tubular assembly 10 are assembled and affixed to the stackable half-tubular assembly 10 by welding, sewing, stapling, clamping and gluing. In other embodiments, the filtering membranes 170 may be removably disposed about the stackable half-tubular assembly 10 without any fastening means.

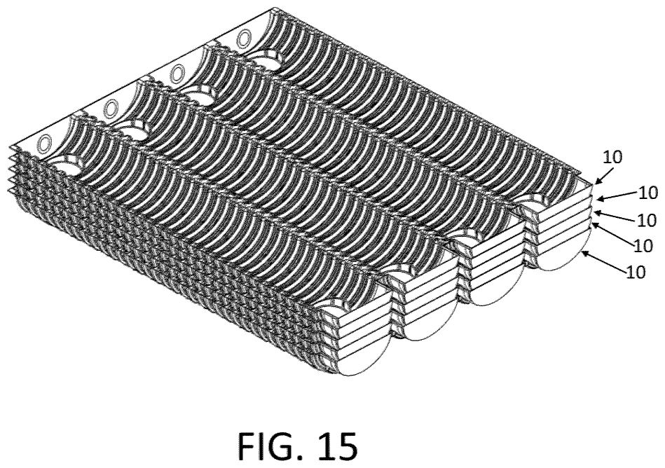

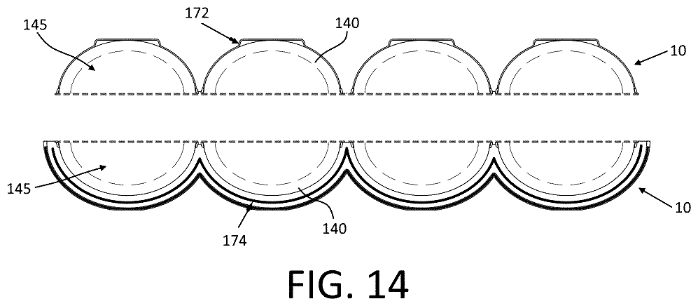

Referring now to FIG. 14, an embodiment where two stackable half-tubular assemblies 10 are wrapped or covered with filtering membranes 170 being one or more filtering layers (172, 174) is shown. The embodied filtering layers (172, 174) may act as an antimicrobial layer and may therefore cover the outer wall sections 140 of a half-tubular section 145 of the stackable half-tubular assembly 10. A first stackable half-tubular assembly 10 may be covered by one filtering layer 172. A second stackable half-tubular assembly 10 may be covered by a filtering layer 174 comprising two or more layers. In some embodiments, each of the layers comprising the filtering layer 174 may have different filtering, antibacterial and/or mechanical characteristics. The filtering layers (172, 174) are configured to filter bacteria going toward or away from the assemblies 10. In another embodiment (not shown), the filtering layers (172, 174) may extend by at least half an inch (around 1.25 cm) or, in some embodiments, an inch and a half (around 3.8 cm), from either side of a stackable half-tubular assembly 10. The filtering layers (172, 174) extending at a given distance from the half-tubular assemblies 10 at each extremity may help prevent unwanted particles from entering in contact with the half-tubular assemblies 10 themselves.

When configured in series, the stackable half-tubular assemblies 10 may be interconnected by means of couplers (not shown) configured to allow a fluid communication between two or more assembled treatment passages 100. In other embodiments however, each stackable half-tubular assembly 10 may comprise a complementary coupler. As such, when two stackable half-tubular assemblies 10 are attached to one another, the two complementary coupler portions form a coupler adapted to attach to another assembled treatment passage 100. Such configuration generally aims at eliminating the need for any additional coupling means.

Referring now to FIGS. 1 to 3, a stackable half-tubular assembly 10 may comprise first and second coupling ends 182, 184 configured to sealingly affix two assembled treatment passages 100 positioned in series. In certain embodiments, the first and second coupling ends 182, 184 may take the form of a male and a female connector wherein the female connector 184 is configured to receive and hold the male connector 182. In the illustrated embodiment, the first coupling end 182 comprises a male connector configured to be received by the female connector of another stackable half-tubular assembly (not shown) installed in series. Similarly, the second coupling end 184 comprises a female connector configured to receive the male connector of another stackable half-tubular assembly (not shown) installed in series. The first and second coupling ends 182, 184 may additionally be configured to receive the distribution device, the end caps or the junction pipe.

In certain embodiments, the first and second coupling ends 182, 184 may additionally comprise means for securing stackable half-tubular assembly 10 disposed in series. For example, the first and second coupling ends 182, 184 may comprise ridges, threading, adhesive or any other suitable means of restricting motion in a longitudinal direction of the stackable half-tubular assembly 10. Still referring to FIGS. 1 to 3, the first coupling end 182 may comprise fasteners 189 disposed on its outer surface.

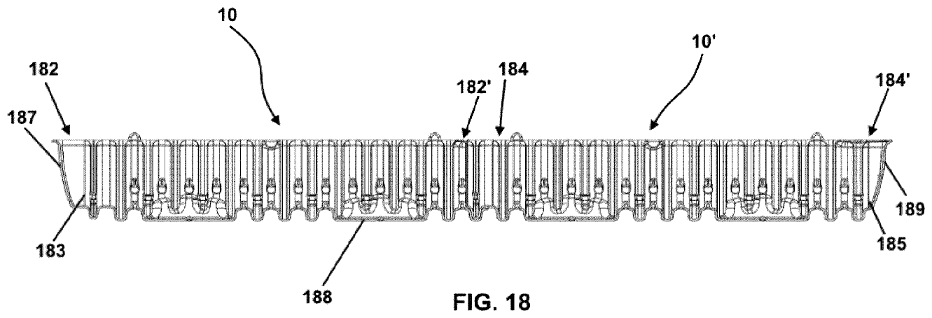

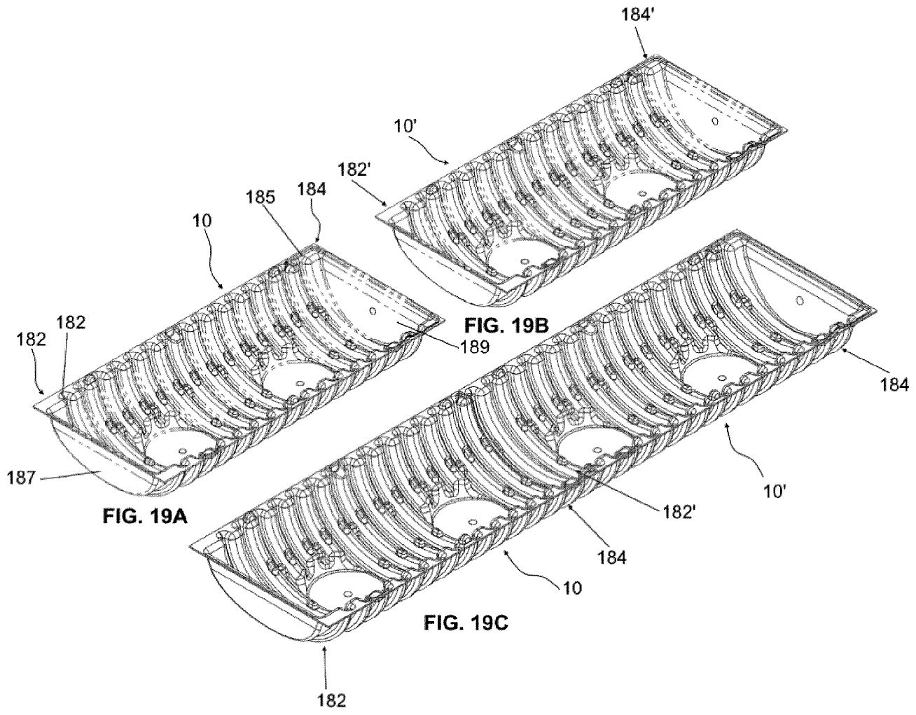

Referring now to FIG. 18 and FIGS. 19A, 19B and 19C, an embodiment of a stackable wastewater treatment basin section 10 connectable in series with one or more other stackable wastewater treatment basin section 10′ is illustrated. Each of the sections 10 and 10′ comprise a first coupling end 182, 182′ and a second coupling end 184, 184′. The first coupling end 182 may comprise an end wall 187 which may be removed. In the illustrated embodiment, the first coupling end 182 comprises a cuttable line or pre-cut line 183. When cut, the end wall is removed and the coupling end 182 is now open. On the other end, the second coupling end 184 may comprise an end wall 189 which may be removed. The second coupling end 184 comprises a cuttable line or pre-cut line 185. When cut, the end wall 189 is removed and the second coupling end 184 is now open.

Referring now to FIG. 19C, two exemplary stackable wastewater treatment basin sections 10 and 10′ are shown connected to form a longer treatment basin. In the illustrated embodiment, the first coupling end 182 is a male connecting section and the second coupling end 184 is a female connecting section. As illustrated, the first coupling end 182′ of the second section 10′, with the end wall 187 removed, is interlocked with the second coupling end 184 of the first section 10. In the illustrated embodiment, the sections 10 and 10′ are interlocked by overlappingly mating ridges and grooves of each section. Understandably, any other mechanism or shape allowing the two coupling ends 182′ and 184 may be used within the scope of the present invention. Also, the present invention is not limited to a number of sections 10 being attached to one another in series.

In certain embodiments, the first and second coupling ends 182, 184 may comprise end walls 186 which may hermetically seal the channel 105 when the treatment passages 100 are assembled. The end walls 186 may be made of the same material as the stackable half-tubular assembly 10 or any other suitable material and may form a single unitary piece therewith. In such embodiments, the end walls 186 may be pierced, cut out or removed in any other suitable manner during installation of the stackable half-tubular assembly 10 to allow a fluid communication between their respective channels 105 and any other element of the drainage field in fluid communication with said channels 105. Referring again to FIG. 1, the end walls 186 may comprise detachable ports 188 capable of being detached to form a predefined smaller aperture into a channel 105 for receiving, for example, the distribution device, the end caps or the junction pipe. In certain embodiments as seen in FIGS. 5 to 8, the wall sections 140 may similarly comprise ports 188 configured to allow fluid communication between the channel 105 and another element affixed to the stackable half-tubular assembly 10 such as, for example, a cavity, an aeration vent, a piezometer or any other suitable system. The ports 188 are typically made with the same material of the wall section 140. In some embodiments, the ports 188 may be detachable or may comprise pre-cut section to ease opening the said ports 188 upon installation.

In a preferred embodiment and referring to FIG. 15, a plurality of stackable half-tubular assemblies 10 in an unassembled configuration may be stacked on top of one another. It may be appreciated that a plurality of stackable half-tubular assemblies 10 occupy far less volume when stacked in an unassembled configuration, as opposed to an assembled configuration or when compared to a traditional drain or treatment basin. In such embodiment, the stackable half-tubular assemblies 10 may be stored and/or transported to an installation site in an unassembled configuration. Once the benefits of an unassembled configuration are no longer required or desirable, each stackable half-tubular assembly 10 may be assembled with another stackable half-tubular assembly 10 to form one or more assembled treatment passages 100 suitable for installation and operation of the wastewater treatment system.

In certain embodiments and referring to FIG. 4, each wall section 140 may have a tubular cross-sectional profile defining an arc having its largest radius of curvature being substantially centered therein. Configured in this manner, the wall sections 140 may form elliptically shaped spacings to better receive wall sections 140 of a stackable half-tubular assembly 10 being stacked thereon, thus occupying less volume when stored or at least minimizing the empty volume.

In a preferred embodiment, two stackable half-tubular assemblies 10 are interchangeable components with each forming a half of the wastewater treatment assembly.

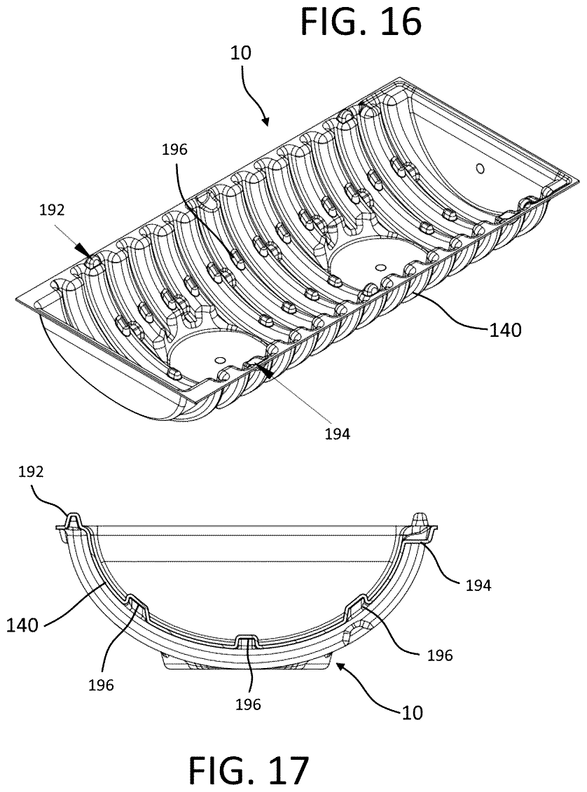

Referring to FIGS. 16 and 17, an embodiment of a wall section 140 comprising securing means (192, 194) is shown. The securing means (192, 194) comprise male securing means 192 and a female securing means 194. In the illustrated embodiment, the male securing means 192 is embodied as a protrusion and the female securing means is embodied as a recess. The attachment sections (122, 132) and/or the securing portions 150 may comprise the securing means (192, 194).

The securing means (192, 194) generally aims at guiding and aligning a stackable half-tubular assembly 10 into one another when assembling the treatment basin 100 and generally aims at preventing displacement of stackable half-tubular assemblies 10 relative to one another when combined. Each of the securing means (192, 194) is adapted to mate with a securing means of the opposite type when the wall section 140 of a first half-tubular assembly 10 is positioned vis-à-vis another wall section 140 of a second half-tubular assembly 10. Accordingly, the securing means (192, 194) may be located at either or both ends of a wall section 140 where contact may be possible with the securing means (192, 194) of another wall section 140. The securing means (192, 194) may further be located longitudinally along the length of the wall section 140. In certain embodiments, male and female securing means (192, 194) may be located alternatively along the length of the wall section 140. In other embodiments, any other type of configuration between male 192, female 194 or both types of connecting means may be used. The shape, size and location of the securing means (192, 194) of other embodiments may differ and are therefore not limited to the shown embodiment.

The wall sections 140 may comprise stacking connectors 196 configured to help secure a stackable half-tubular assembly 10 stacked on top of another stackable half-tubular assembly 10. The stacking connectors 196 are embodied as protrusions on one side of the wall section 140, therefore creating a recess on the opposing side of the same. Therefore, the protruding side of the stacking connector 196 of a bottom stackable half-tubular assembly 10 will enter in the hole of the correlating stacking connector 196 of a stackable half-tubular assembly 10 that is stacked on top. Understandably, the shape, size and location of the stacking connectors 196 of other embodiments may differ and are therefore not limited to the shown embodiments.

The present invention also provides a method for manufacturing and installing a stackable half-tubular assembly 10.

Manufacturing the stackable half-tubular assembly 10 may comprise injecting molten material into a mould having the shape of the stackable half-d tubular assembly 10 comprising a predetermined number of channels 105 and of the securing portion 150. The manufacturing of the stackable half-tubular assembly 10 may, in some embodiments, comprise forming distinct partitions 140 and attaching the said partitions 140 along their length using one or more securing portions 150.

The method of installation of one or more closed treatment basins or passages 100 comprises placing and aligning a first stackable half-tubular assembly 10 atop a second stackable half-tubular assembly 10 such as to align their outer lateral edges 122 and 132, the partitions 140 with their corresponding partitions 140 and affixing the aligned portions to one another. Affixing the two stackable half-tubular assemblies 10 to one another may comprise attaching the outer lateral edges 122 and 132 of the stackable half-tubular assemblies 10 to one another using any suitable attachment means, such as gluing, sewing, clamping, etc. In yet another embodiment, each of the outer lateral edges 122 and 132 may comprise a male and female connector allowing to be mated to one another, such as snapping the two portions together.

The method of assembly or installation may further comprise aligning male 192 and female 194 securing means located on the top half-tubular assembly 10 with corresponding female 194 or male 192 securing means located on the bottom half-tubular assembly 10.

The method of assembly or installation may further comprise surrounding or wrapping the assembled stackable half-tubular assemblies 10 with a filtering membrane 170. The filtering membrane 170 being an antibacterial single layer 172 on the top stackable half-tubular assembly 10 and a plurality of antibacterial layers 174 on the bottom stackable half-tubular assembly 10. The method may further comprise affixing the assembled drains 10 to other drainage tubes or systems in a series by means of the first and second coupling ends 182, 184.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A stackable wastewater treatment basin section comprising a wall defining one or more cavities, the one or more elongated cavities being configured to retain wastewater, an inner side of the wall being adapted to receive an outer side of the wall of another stackable wastewater treatment basin section of the same configuration.

2. The stackable wastewater treatment basin section of claim 1 comprising two cavities and a securing portion between each of the two elongated cavities.

3. The stackable wastewater treatment basin section of claim 2, each cavity comprising an outer lip adapted to be secure to an outer lip of another stackable wastewater treatment basin section of the same configuration.

4. The stackable wastewater treatment basin section of claim 1 comprising a securing portion adapted to mate with a securing portion of another stackable wastewater treatment basin section.

5. The stackable wastewater treatment basin section of claim 4, the securing portion allowing relative adjustments between the two or more half-tubular wall sections.

6. The stackable wastewater treatment basin section of claim 1 comprising corrugations along each the inner wall section, the corrugations being adapted to mate with corresponding corrugations present on an outer wall of another stackable wastewater treatment basin section.

7. The stackable wastewater treatment basin section of claim 1, the cavity being U-shaped.

8. The stackable wastewater treatment basin section of claim 1, the stackable wastewater treatment basin section comprising stacking connectors on an inner side of the wall mating with stacking connectors of an outer side of a wall of another stackable wastewater treatment basin section.

9. The stackable wastewater treatment basin section of claim 1, the stackable wastewater treatment basin section comprising a filtering layer over an outer surface of the cavity.

10. The stackable wastewater treatment basin section of claim 10, the filtering layer extending away from extremities of the stackable wastewater treatment basin section.

11. The stackable wastewater treatment basin section of claim 1 comprising ports configured to allow fluid communications with other fluid systems.

12. The stackable wastewater treatment basin section of claim 11, the ports being detachable.

13. The stackable half-wastewater treatment basin of claim 1 comprising a first connector at a first longitudinal end and a second connector at a second longitudinal end, the first connector being configured to mate with a second connector of another stackable wastewater treatment basin section.

14. A wastewater treatment basin assembly comprising a first and second stackable wastewater treatment basin sections, each stackable wastewater treatment basin section comprising a wall defining one or more elongated cavities, the one or more cavities being configured to retain wastewater, an inner side of the wall being adapted to receive an outer side of the wall of another stackable wastewater treatment basin section of the same configuration;
wherein the first and second wastewater treatment basin sections are attached to one another to form an enclosed wastewater treatment basin adapted to receive a fluid.

15. The wastewater treatment basin assembly of claim 14, each of the first and second wastewater treatment basin sections comprising two cavities and a securing portion between each of the two elongated cavities.

16. The wastewater treatment basin assembly of claim 15, each cavity comprising an outer lip adapted to be secure to an outer lip of another stackable wastewater treatment basin section of the same configuration.

17. The wastewater treatment basin assembly of claim 15, the securing portion allowing relative adjustments between the walls of the two cavities.

18. The wastewater treatment basin assembly of claim 14, each stackable wastewater treatment basin section comprising corrugations along its inner wall section, the corrugations being adapted to mate with corresponding corrugations present on an outer wall of another stackable wastewater treatment basin section.

19. The wastewater treatment basin assembly 14, each stackable wastewater treatment basin section comprising male and female securing means configured to secure the first stackable wastewater treatment basin section to the second stackable wastewater treatment basin section.

20. A method of installing a wastewater treatment basin comprising:
laying a first stackable wastewater treatment basin section on a surface for an inner wall defining one or more elongated cavities to face upward;
positioning a second stackable wastewater treatment basin section on top of the upwardly facing cavity of the first stackable wastewater treatment basin section to form an enclosed wastewater treatment basin between the inner walls of the cavities of the first and second stackable wastewater treatment basin sections; and
securing the first stackable wastewater treatment basin to the second stackable wastewater treatment basin.

21. The method of claim 20 further comprising surrounding the positioned first and second stackable wastewater treatment basin sections with a filtering membrane.

22. The method of claim 20 further comprising:
aligning a first securing connector of the first stackable wastewater treatment basin section with a second securing connector of the second stackable wastewater treatment basin section; and
securing the first and second connectors to one another.

23. The method of claim 20 further comprising mating a first connector at a first longitudinal end of the formed wastewater treatment basin to a second connector at a second longitudinal end of another formed wastewater treatment basin.

24. The method of claim 20 further comprising fluidly connecting a port of the formed wastewater treatment basin to another fluid system.
